(19) United States
(12) Patent Application Publication
(10) Pub. No.: US 2024/0217128 A1
(43) Pub. Date: Jul. 4, 2024

(54) Glow in the Dark Clipper Cutting Guard

(71) Applicant: Ehimare Ojefua, New York, NY (US)

(72) Inventor: Ehimare Ojefua, New York, NY (US)

(21) Appl. No.: 18/091,428

(22) Filed: Dec. 30, 2022

(51) Int. Cl. B26B 19/20; B26B 19/38; B26B 19/46

(52) U.S. Cl. CPC B26B 19/20; B26B 19/3813; B26B 19/46

(57) ABSTRACT

The present invention is a clipper cutting guard for use with a hairstyling clipper having a glow in the dark material on an outer surface of the clipper cutting guard.

### BACKGROUND OF THE INVENTION

The hairstylist relies on their skill and their instruments. There is an ever-increasing number of implements available to the artisan. However, most hairstylists will tell you there is a particular aspect of the profession that often goes unaddressed. The hairstylist often is not in complete control of the workspace. Salons have pre-installed lighting and often there are shadows and/or insufficient lighting in the workspace.

There is a long needed an unmet need for the hairstylist to have sufficient lighting when using the tools of their profession.

The present invention addresses this need.

### SUMMARY OF THE INVENTION

In one embodiment, the invention is a Glow in the Dark clipper guard.

The clipper guard includes glow in the dark material to provide clear visibility in low light conditions.

In one embodiment, the glow in the dark material imparts clear visibility in low light and is affixed to the clipper head using a magnet for secure adhesion

In one embodiment, there is an extra bottom lip for added adhesion.

This invention will solve the readability of the guards' indicia and in turn help the hairstylist streamline the hair styling process.

In one embodiment, the present invention is a glow in the dark clipper cutting guard comprising:
a clipper cutting guard constructed and arranged to affix to a hairstyling clipper; and
a glow in the dark material operatively associated therewith on an outer surface of said clipper cutting guard.

In one embodiment, the cutting guard glow in the dark material is a solid film affixed to said outer surface.

In one embodiment, the glow in the dark material is liquid applied to said outer surface wherein said liquid dries and forms a film affixed thereto.

In one embodiment, the glow in the dark material is applied to said outer surface using a film having an adhesive disposed thereon.

In one embodiment, the glow in the dark material includes a film having magnetic material on one surface wherein said magnetic material magnetically affixes said film to said outer surface.

In one embodiment, the glow in the dark material is phosphorescent.

In one embodiment, the glow in the dark material further illuminates size indicia on said clipper cutting guard.

In one embodiment, the present invention is a glow in the dark clipper cutting guard consisting of:
a clipper cutting guard constructed and arranged to affix to a hairstyling clipper; and
a glow in the dark material operatively associated therewith on an outer surface of said clipper cutting guard.

### BRIEF DESCRIPTION OF DRAWINGS

FIG. 1 is a perspective view of the clipper head on a clipper according to one embodiment of the present invention.

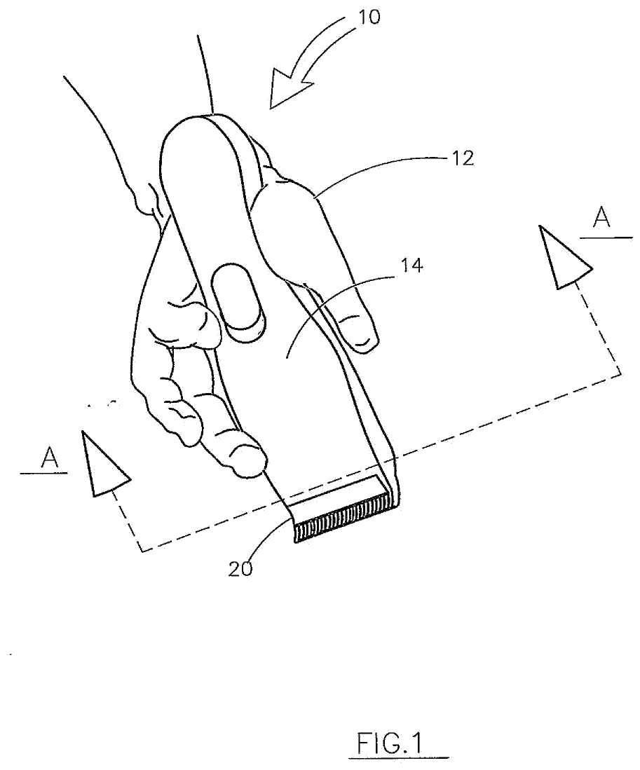

FIG. 2 is a cross section from section A-A of FIG. 1.

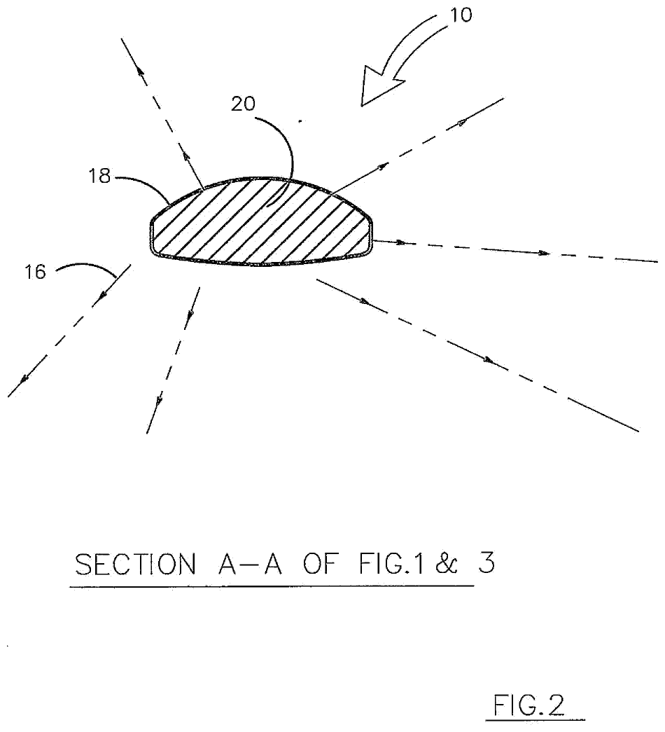

FIG. 3 is a perspective view of the clipper head according to one embodiment of the present invention.

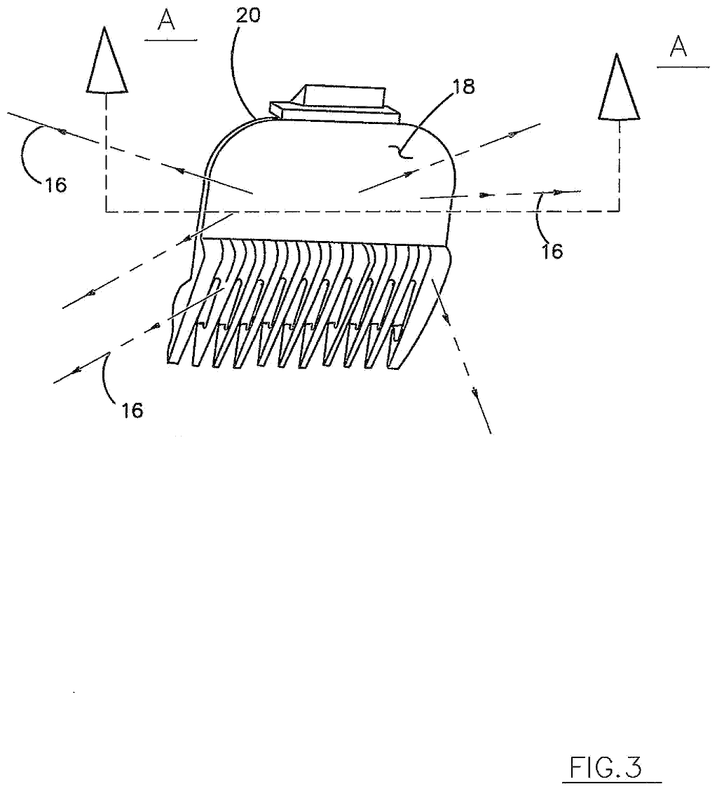

### DETAILED DESCRIPTION OF THE INVENTION

Although the drawings depict a particularized embodiment, the present invention is contemplated as configurable in any physical structure whereby the inventive scope and concept are achieved.

The system of the present invention includes a cutting guard 20 positioned on an existing conventional hair clipper 14. A glow in the dark material 18 is operatively associated with the surface of cutting guard 20. In one embodiment, glow in the dark material 18 is provided as a solid sheet or film affixed to cutting guard 20.

In another embodiment, a liquid material is applied to the outer surface of cutting guard 20 and is permitted to dry forming a glow in the dark film 18 on the outer surface of cutting guard 20.

As generally understood, glow in the dark material 18 emanates light 16 outward from cutting guard 20. When the skilled hairstylist utilizes a cutting guard 20 having glow in the dark material 18 associated there with, the emanated light 16 provides additional light by which the hairstylist uses in their work.

In one embodiment, glow in the dark material 18 has adhesive affixed to one side and is adhered to cutting guard 20.

In another embodiment, glow in the dark material 18 has a magnet affixed to one side and is magnetically adhered to cutting guard 20.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention. t least one specification heading is required. Please delete this heading section if it is not applicable to your application. For more information regarding the headings of the specification, please see MPEP 608.01(a).

1. A glow in the dark clipper cutting guard comprising:
a clipper cutting guard constructed and arranged to affix to a hairstyling clipper; and
a glow in the dark material operatively associated therewith on an outer surface of said clipper cutting guard.

2. The clipper cutting guard of claim 1 wherein said glow in the dark material is a solid film affixed to said outer surface.

3. The clipper cutting guard of claim 1 wherein said glow in the dark material is liquid applied to said outer surface wherein said liquid dries and forms a film affixed thereto.

4. The clipper cutting guard of claim 1 wherein said glow in the dark material is applied to said outer surface using a film having an adhesive disposed thereon.

5. The clipper cutting guard of claim 1 wherein said glow in the dark material includes a film having magnetic material on one surface wherein said magnetic material magnetically affixes said film to said outer surface.

6. The clipper cutting guard of claim 1 wherein said glow in the dark material is phosphorescent.

7. The clipper cutting guard of claim 1 wherein said glow in the dark material further illuminates size indicia on said clipper cutting guard.
